(19) United States
(12) Patent Application Publication
(10) Pub. No.: US 2026/0221734 A1
(43) Pub. Date: Jul. 30, 2026

(54) Aerial Spool Mechanisms for Stringing Cable

(71) Applicant: Jeremy D. Van Vliet, Lincoln, CA (US)

(72) Inventor: Jeremy D. Van Vliet, Lincoln, CA (US)

(21) Appl. No.: 19/041,259

(22) Filed: Jan. 30, 2025

(51) Int. Cl. H02G 1/02; B64D 1/22

(52) U.S. Cl. CPC H02G 1/02; B64D 1/22

(57) ABSTRACT

An aerial spool mechanism suspended from an aircraft for stringing cable across utility poles includes a remotely adjustable electromechanical brake system for preventing a cable spool from paying out cable too quickly. Some examples of the aerial spool mechanism include a main axle and a spool axle, both of which are rotatable and readily separated for exchanging a depleted cable spool for a new one. In some examples, an adjustable torque arm locks the cable spool to the spool axle, so the two rotate together as a unit.

### FIELD OF THE DISCLOSURE

This patent generally pertains to aircraft-suspended spool mechanisms for paying out cable and more specifically to mechanisms for stringing cable across utility poles.

### BACKGROUND

An apparatus known as a “stringer” can be suspended from a helicopter to facilitate installing or replacing electrical power lines across a series of utility poles. Stringers are particularly useful when the utility poles are in areas that are difficult to reach by truck. Stringers usually include a frame with an axle for supporting a cable spool. To slow the release of cable, some stringers use a brake belt draped over the cable spool, as disclosed in U.S. patent publication No. 2024/0150150 A1.

### BRIEF DESCRIPTION OF THE DRAWINGS

FIG. 1 is a perspective view of an example aerial spool mechanism suspended from an aircraft and shown in use stringing cable across a series of utility poles, wherein the example aerial spool mechanism is constructed in accordance with the teachings disclosed herein.

FIG. 2 is a perspective view of the aerial spool mechanism shown in FIG. 1 but without the cable spool.

FIG. 3 is a perspective view similar to FIG. 2 but showing the cable spool installed.

FIG. 4 is similar to FIG. 2 but showing a back view of the aerial spool mechanism.

FIG. 5 is similar to FIG. 3 but showing a back view of the aerial spool mechanism with the cable spool installed.

FIG. 6 is a left side view of FIG. 4.

FIG. 7 is a schematic view of an example electromechanical brake system of the aerial spool mechanism, wherein the electromechanical brake system is constructed in accordance with the teachings disclosed herein.

FIG. 8 is a cross-sectional view taken along line 8-8 of FIG. 6, wherein the aerial spool mechanism is in an operational configuration.

FIG. 9 is a cross-sectional view similar to FIG. 8 but showing the aerial spool mechanism in a reload configuration.

### DETAILED DESCRIPTION

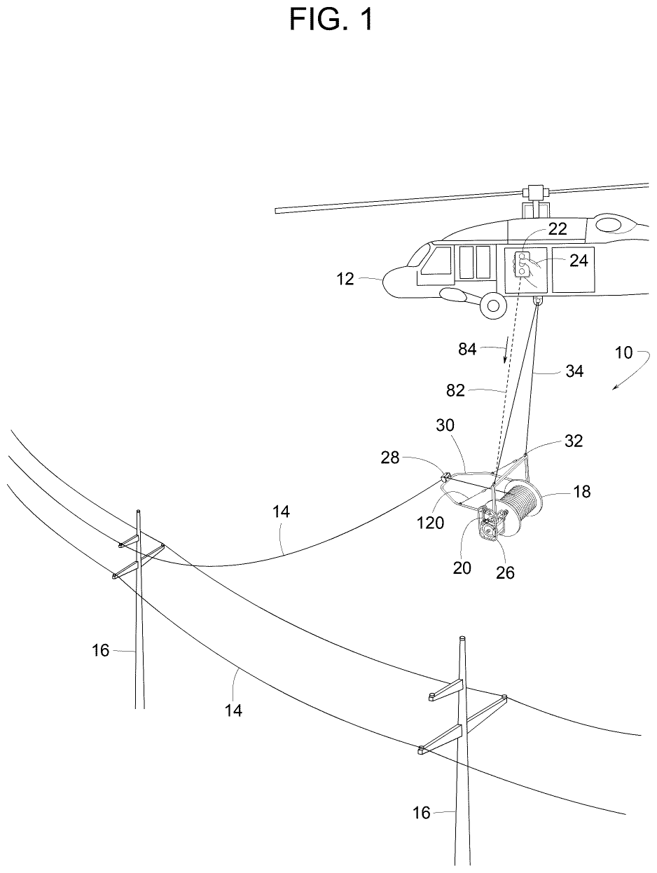

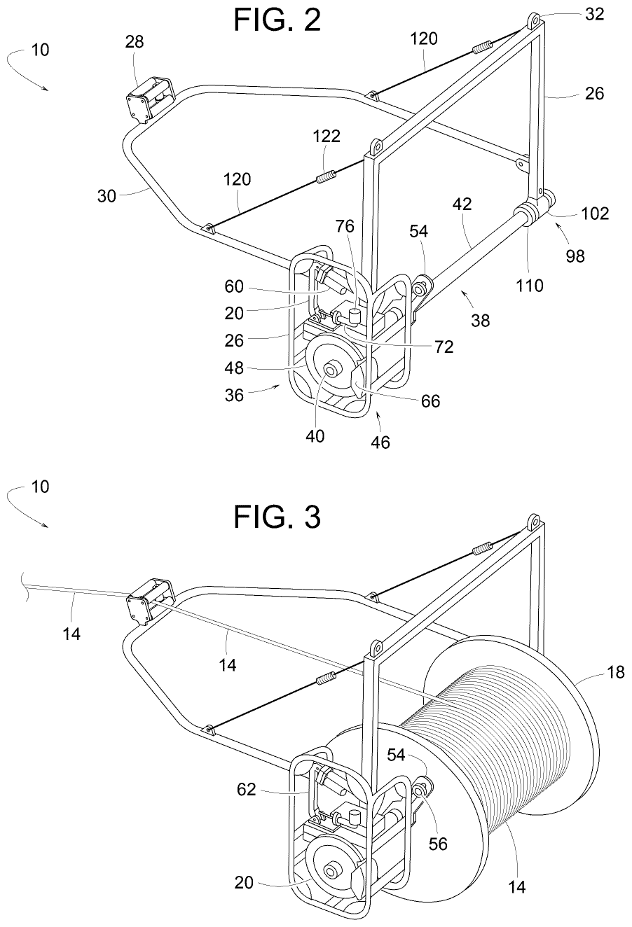

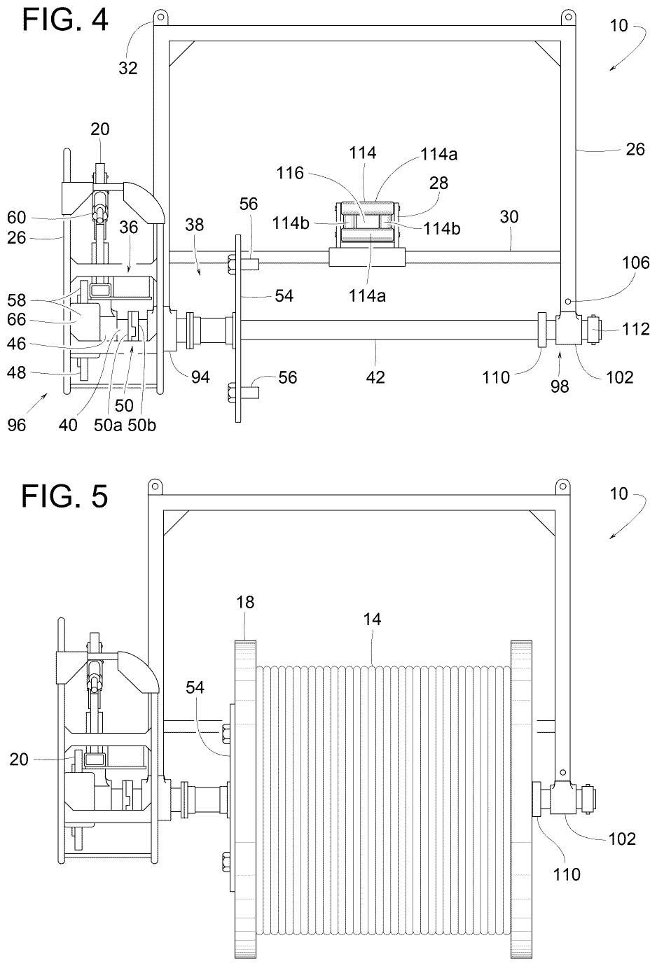

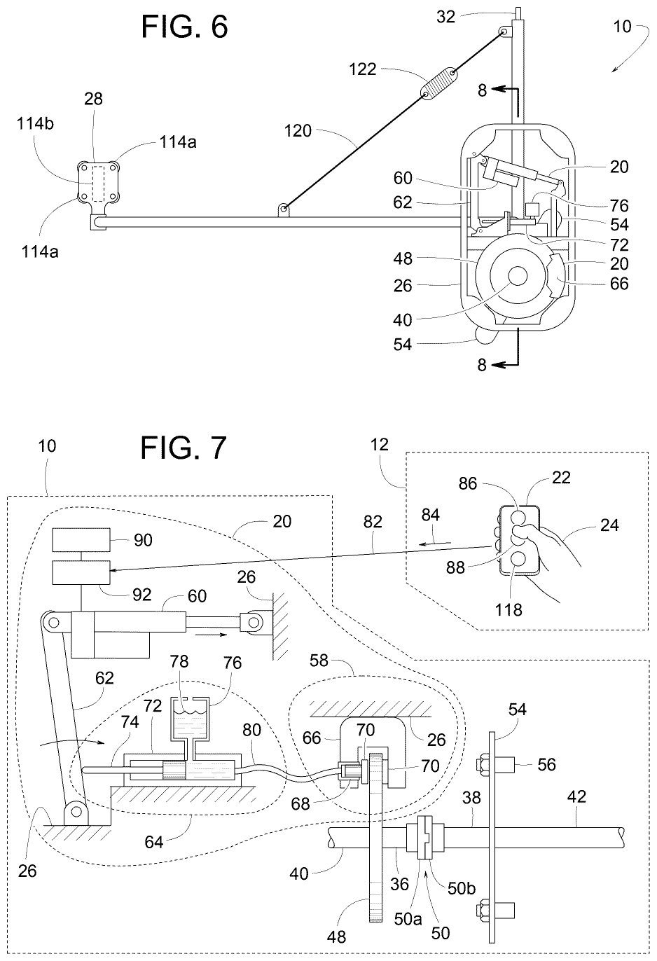

FIGS. 1-9 illustrate an aerial spool mechanism 10 that can be suspended from an aircraft 12 (e.g., a helicopter, a drone, etc.) and used for efficiently stringing cable 14 (e.g., electrical power cable, bare cable, insulated cable, communication cable, fiber optic cable, etc.) across a series of utility poles 16. The original cable 14 comes from a manufacturer wrapped about a disposable or reusable cable spool 18, which can be mounted to and carried by the aerial spool mechanism 10. To payout the cable 14 as needed, the spool 18 is rotated by forcibly pulling the free end of the cable 14 out from the aerial spool mechanism 10.

To prevent excess or uncontrolled release of the cable 14, the aerial spool mechanism 10 includes an electromechanical brake system 20. The term, “electromechanical brake system,” refers to any electrically powered apparatus that produces frictional drag to slow down motion. In some examples, a remote controller 22 (FIG. 7) in the aircraft 12 enables a user 24 (e.g., a pilot or a crew member) to control the electromechanical brake system 20 to adjust the rotational drag applied to the spool 18. Such adjustment can be important, as the required drag can change depending on the free length of the cable 14 and its weight.

Some examples of the aerial spool mechanism 10 include a main frame 26, a cable guide 28 attached to an extended arm 30 of the main frame 26, and at least one lift point connector 32 (e.g., a lug, a link, a clevis, a shackle, a loop, a hook, a clasp, carabiner, etc.) on the main frame 26. The connector 32 provides a lift point for hanging the aerial spool mechanism 10 by a lifting cable 34 (or strap) attached to the aircraft 12. The term, “cable guide,” refers to any apparatus defining an opening through which a cable can smoothly slip.

In some examples, the aerial spool mechanism 10 also includes both a main axle assembly 36 and a spool axle assembly 38 supported by the main frame 26. The main axle assembly 36, in some examples, includes a main axle 40 connected to and rotated by a spool axle 42 of the spool axle assembly 38.

In some examples, the main axle assembly 36 includes the main axle 40, one or more main rolling element bearings 44, a main bearing housing 46 attached to the main frame 26, a brake rotor 48 affixed to the main axle 40, and a main coupling portion 50a of a disconnectable coupling 50. The main rolling-element bearing 44 in the main bearing housing 46 supports the main axle 40. The main coupling portion 50a is affixed to the main axle 40 and provides means for connecting to the spool axle 42. In some examples, the brake rotor 48 is part of both the main axle assembly 36 and the electromechanical brake system 20.

In some examples, the spool axle assembly 38 includes the spool axle 42, a spool rolling element bearing 52 supported by the main frame 26 and supporting the spool axle 42, a torque arm 54 affixed to the spool axle 42, and a spool coupling portion 50b of the disconnectable coupling 50. The spool coupling portion 50b is affixed to the spool axle 42 and matingly engages the main coupling portion 50a, so both coupling portions 50a and 50b rotate together along with the rotation of the main axle 40 and the spool axle 42. The disconnectable coupling 50 is schematically illustrated, as portions 50a and 50b can be of any suitable mating geometry that allows torque to be transmitted between the two coupling portions 50a and 50b.

The torque arm 54 transmits torque between the spool axle 42 and the cable spool 18. In some examples, the torque arm 54 includes two posts 56 that extend into openings in a side disc of the cable spool 18, so the torque arm 54 and the cable spool 18 rotate as a unit. In some examples, the positions of the posts 56 are adjustable radially along the length of the torque arm 54 to fit cable spools 18 of different diameters.

To provide the cable spool 18, the spool axle 42 and the main axle 40 with adjustable rotational drag, some examples of the electromechanical brake system 20 include a brake 58, an electric actuator 60 to operate the brake 58, a lever 62 for multiplying the force exerted by the electric actuator 60, and a hydraulic coupler 64 that connects electric actuator 60 and the lever 62 to the brake 58. The term, “electric actuator,” refers to any apparatus that converts electrical energy to mechanical work. Some examples of the electric actuator 60 include linear actuators, motor driven leadscrews, motor driven rack and pinion mechanisms, and motor driven linkages. The term, “hydraulic coupler,” refers to any apparatus that uses a liquid for transmitting a force from one device to another.

In some examples, as shown in FIG. 7, the brake 58 is a known disc brake that includes the brake rotor 48, a brake caliper 66 with a wheel cylinder 68 and brake pads 70. The brake caliper 66 is supported by the main frame 26, and the brake pads 70 engage the brake rotor 48.

In some examples, the hydraulic coupler 64 is a master cylinder 72 with a piston rod 74 and a reservoir 76 containing a fixed charge of hydraulic fluid 78. The lever 62 pushing against the piston rod 74 forces hydraulic fluid 78 through a hose 80 leading to the brake 58. In examples where the brake 58 is a disc brake, as shown in FIG. 7, pressurized hydraulic fluid in the hose 80 forces the wheel cylinder 68 to push the brake pads 70 forcibly against the brake rotor 48. This applies rotational drag to the brake rotor 48, which provides a certain amount of resistance to the rotation of the main axle 40, the spool axle 42 and the cable spool 18.

The rotational drag or braking force is adjusted by varying the extent to which the electric actuator 60 retracts. The more it retracts, the more the lever 62 pushes against the piston rod 74 of the master cylinder 72.

In some examples, the distance the electric actuator retracts 60 is a function of how long the electric actuator 60 is energized to retract. Conversely, the distance the electric actuator 60 extends is a function of how long the electric actuator 60 is energized to extend.

In some examples, the electric actuator's time of extending and retracting is controlled by the remote controller 22. The term, “remote” means that the remote controller 22 is at least two meters away from the electromechanical brake system 20, which allows at least minimal separation between the aircraft 12 and the aerial spool mechanism 10.

A communication link 82 connects the remote controller 22 in signal communication with the electromechanical brake system 20 such that the electromechanical brake system 20 applies an adjustable rotational drag to the main axle 40 (e.g., via the brake rotor 48), wherein the adjustable rotational drag varies in response to an output signal 84 of the remote controller 22. The communication link 82 is schematically illustrated in FIGS. 1 and 7 to represent any means for conveying the output signal 84 at least two meters from the remote controller 22 to the electromechanical brake system 20. This allows the remote controller 22 to be in the aircraft 12 while the electromagnetic brake system 20 can be multiple meters away. Some examples of the communication link 82 include an electrical wire of at least two meters long, an optical cable, a wireless path for radio waves or some other known electromagnetic radiation, etc.

In some examples, the remote controller 22 provides the user 24 with a first button 86 and a second button 88 for initiating the output signal 84. In some examples, manually pressing the first button 86 commands the electric actuator 60 to retract, thereby increasing the braking force. The duration in which the first button 86 is pressed determines how long the electric actuator 60 operates and thus how much the braking force increases. Conversely, in some examples, manually pressing the second button 88 commands the electric actuator 60 to extend, thereby decreasing the braking force. The duration in which the second button 88 is pressed determines how much the braking force decreases.

In some examples, the electromechanical brake system 20 includes an electric power supply 90 (e.g., a battery) and a known electric circuit 92. The electric power supply 90, in some examples, energizes the electric circuit 92 and powers the electric actuator 60. The electric circuit 92 transmits the output signal 84 in a way the electric actuator 60 can receive and act upon it.

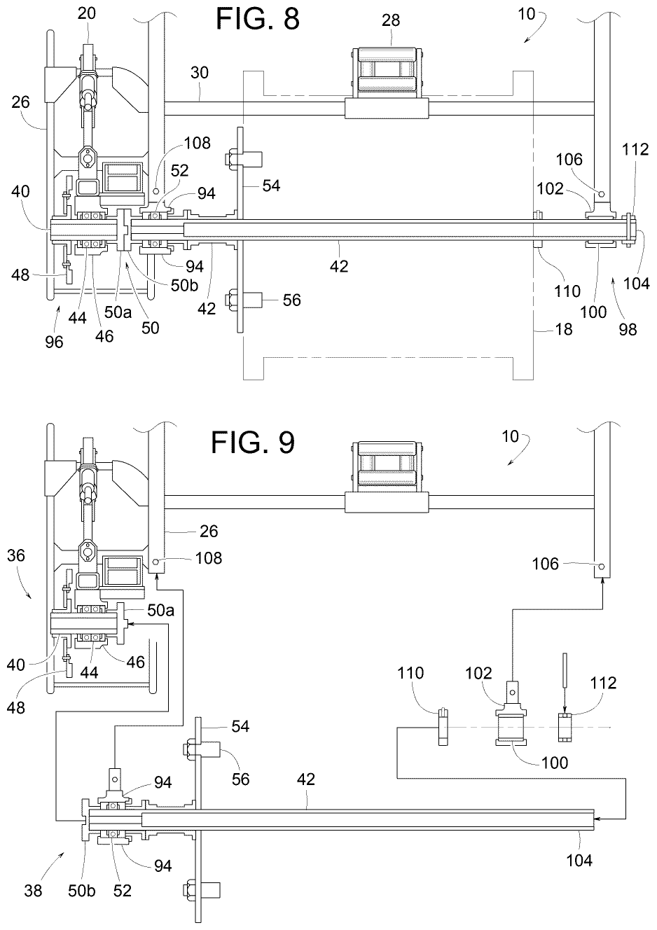

In some examples, the disconnectable coupling 50 connects the spool axle 42 to the main axle 40. The disconnectable coupling 50 makes the aerial spool mechanism 10 selectively reconfigurable to an operational configuration (FIG. 8) and a reload configuration (FIG. 9). In the operational configuration, the spool axle 42 is supported by the main frame 26 and coupled to the main axle 40, making the aerial spool mechanism 10 ready for use, as shown in FIG. 1.

In the reload configuration, the spool axle assembly 38 is separated from the rest of the aerial spool mechanism 10, leaving the spool axle 42 free and available for unloading a depleted cable spool 18 and replacing it with a new one. In some examples, an aerial spool mechanism 10 can be in use, as shown in FIG. 1, while one or more additional spool axle assemblies 38 are preloaded with new cable spools 18 and held in queue for quick swaps with depleted ones. Some examples of the reload configuration facilitate quick assembly by having the spool axle 42, the spool rolling-element bearing 52, a spool bearing housing 94, and the torque arm 54 each spaced apart from the main frame 26, as shown in FIG. 9.

In the operational configuration, the spool axle 42 and the spool rolling-element bearing 52 in the spool bearing housing 94 are supported by the main frame 26 at an inboard end 96 of the aerial spool mechanism 10, as shown in FIG. 8. At an outboard end 98 of aerial spool mechanism 10, a distal bearing 100 (e.g., a rolling element bearing, a journal bearing, a sleeve bearing, a bushing, etc.) in a distal bearing housing 102 connects a distal end 104 of the spool shaft 42 to the main frame 26 at the outboard end 98 of the aerial spool mechanism 10.

In some examples, a fastener 106 (e.g., a screw, a bolt, a pin, a clip, a clamp, etc.) makes the distal bearing housing 102 removable from the frame 26, facilitating switching between the operational configuration and the reload configuration. In some examples, a fastener 108 (e.g., a screw, a bolt, a pin, a clip, a clamp, etc.) makes the spool bearing housing 94 removable from the frame 26, facilitating switching between the operational configuration and the reload configuration.

Some examples of the aerial spool mechanism 10 include a collar clamp 110. The collar clamp 110 can be slid adjustably along the length of the spool axle 42, positioned up against the cable spool 18, and then locked in place to hold the cable spool 18 against the torque arm 54. In some examples, a clip retainer 112 at the distal end 104 of the spool shaft 42 helps hold the spool axle assembly 38 together in the operational configuration configuration.

In some examples, the cable guide 28 includes six rollers 114, e.g., four horizontal ones 114a and two vertical ones 114b. In some examples, each of the horizontal rollers 114a is longer than a width of a cable opening 116 defined by the rollers 114. In some examples, each of the vertical rollers 114b is longer than a height of the cable opening 116. Such a roller arrangement prevents a cable or cable strand from getting pinched at the corners of the cable opening.

In some examples, the remote controller 10 includes one or more additional buttons, e.g., a third button 118 for additional functions. Some examples of such additional functions include full release of the brake 58 (0% braking) or maximum clamping of the brake 58 (100% braking force). In some examples, momentarily pressing the third button 118 moves the electromechanical brake system 20 to some predetermined braking force (e.g., 25%, 50%, 75%, etc.). In some examples, momentarily pressing the third button 118 automatically energizes the electric actuator 60 for a predetermined period of time (e.g., extend two seconds, retract one second, etc.). In some examples, momentarily pressing the third button 118 automatically returns the electric actuator 4 to its previous position, like a Ctl-Z function of common software programs.

In some examples, the frame 26 includes two guy wires 120 for supporting the extended arm 30 that holds the cable guide 28. Some examples include a shock absorber 122 to minimize peak loads. Some examples of the shock absorber 122 include a coil spring, an elastic strap, a gas spring, etc. In some examples, the shock absorber 122 is a drawbar spring for overload prevention.

Some examples of the aerial spool mechanism 10 can be defined by the following eleven examples (Example-1-Example-11):
Example-1 An aerial spool mechanism for carrying a cable spool suspended from an aircraft, the aerial spool mechanism comprising: a main frame; a cable guide attached to the main frame; a lift point connector on the main frame to facilitate hanging the aerial spool mechanism in suspension from the aircraft; an axle supported by the main frame and being situated to support the cable spool when the main frame is hanging in suspension; an electromechanical brake system supported by the main frame; and a battery supported by the main frame to power the electromechanical brake system.
Example-2 The aerial spool mechanism of Example-1, further comprising: a remote controller spaced at least two meters from the main frame, the remote controller providing an output signal; and a communication link connecting the remote controller in signal communication with the electromechanical brake system such that the electromechanical brake system applies an adjustable rotational drag to the axle, wherein the adjustable rotational drag varies in response to the output signal of the remote controller.
Example-3 The aerial spool mechanism of Example-2, wherein the communication link is a wireless communication link with a range of at least two meters.
Example-4 The aerial spool mechanism of Example-1, wherein the electromechanical brake system includes a brake and an electric actuator; the brake being connected to deliver rotational drag to the axle, and the electric actuator being connected to control the brake.
Example-5 The aerial spool mechanism of Example-4, wherein the electromechanical brake system includes a lever and a master cylinder, wherein the electric actuator acts upon the lever, the lever acts upon the master cylinder, and the master cylinder delivers hydraulic pressure to the brake.
Example-6 The aerial spool mechanism of Example-4, wherein the brake is a disc brake.
Example-7 The aerial spool mechanism of Example-1 further comprising a torque arm attached to the axle and being rotatable therewith, the torque arm being connectable to the cable spool to inhibit relative rotation between the cable spool and the axle.
Example-8 An aerial spool mechanism for carrying a cable spool suspended from an aircraft, the aerial spool mechanism comprising: a main frame; a cable guide attached to the main frame; a lift point connector on the main frame to facilitate hanging the aerial spool mechanism in suspension from the aircraft; an axle being rotatable relative to the main frame, the axle being situated to support the cable spool when the main frame is hanging in suspension; and a torque arm attached to the axle and being rotatable therewith, the torque arm being connectable to the cable spool to inhibit relative rotation between the cable spool and the axle.
Example-9 The aerial spool mechanism of Example-8, further comprising an electromechanical brake system supported by the main frame and being connected to provide the axle with rotational drag.
Example-10 The aerial spool mechanism of Example-9, further comprising: a remote controller spaced at least two meters from the main frame, the remote controller providing an output signal; and a communication link connecting the remote controller in signal communication with the electromechanical brake system such that the electromechanical brake system applies an adjustable rotational drag to the axle, wherein the adjustable rotational drag varies in response to the output signal of the remote controller.
Example-11 The aerial spool mechanism of Example-9, wherein the electromechanical brake system includes an electric actuator, a brake and a hydraulic coupler; the brake being connected to deliver rotational drag to the axle, and the hydraulic coupler coupling the electric actuator to the brake.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An aerial spool mechanism for carrying a cable spool suspended from an aircraft, the aerial spool mechanism comprising:
a main frame;
a cable guide attached to the main frame;
a lift point connector on the main frame to facilitate connecting the aerial spool mechanism in suspension from the aircraft;
a main axle supported by the main frame;
a spool axle supported by the main frame and connected to rotate the main axle;
an electromechanical brake system comprising an electric actuator coupled to a brake, the electric actuator being supported by the main frame, the brake being connected to the main axle;
a remote controller spaced at least two meters from the main frame, the remote controller providing an output signal; and
a communication link connecting the remote controller in signal communication with the electromechanical brake system such that the electromechanical brake system applies an adjustable rotational drag to the main axle, wherein the adjustable rotational drag varies in response to the output signal of the remote controller.

2. The aerial spool mechanism of claim 1, further comprising a hydraulic coupler that couples the electric actuator to the brake.

3. The aerial spool mechanism of claim 1, further comprising a hydraulic coupler that couples the electric actuator to the brake, and the hydraulic coupler includes a fixed charge of a hydraulic fluid.

4. The aerial spool mechanism of claim 1, wherein the electromechanical brake system includes a lever and a master cylinder, wherein the electric actuator acts upon the lever, the lever acts upon the master cylinder, and the master cylinder delivers hydraulic pressure to the brake.

5. The aerial spool mechanism of claim 1, wherein the brake is a disc brake.

6. The aerial spool mechanism of claim 1, wherein the communication link includes an electrical wire of at least two meters long connecting the remote controller to the electromechanical brake system.

7. The aerial spool mechanism of claim 1, wherein the electromechanical brake system includes a power supply supported by the main frame and an electrical circuit connecting the power supply to the electric actuator, and the communication link is a wireless communication link with a range of at least two meters to connect the remote controller in signal communication with the electrical circuit.

8. The aerial spool mechanism of claim 7, wherein the power supply is a battery.

9. The aerial spool mechanism of claim 1, further comprising a disconnectable coupling connecting the spool axle to the main axle.

10. An aerial spool mechanism for carrying a cable spool suspended from an aircraft, the aerial spool mechanism having selectively an operational configuration and a reload configuration, the aerial spool mechanism comprising:
a main frame;
a cable guide attached to the main frame;
a lift point connector on the main frame to facilitate connecting the aerial spool mechanism in suspension from the aircraft;
a main rolling-element bearing on the main frame;
a main axle supported by the main rolling-element bearing;
a spool axle to hold the cable spool, the spool axle being connected to rotate the main axle when the aerial spool mechanism is in the operational configuration, the spool axle being spaced apart from the main axle when the aerial spool mechanism is in the reload configuration;
a spool rolling-element bearing on the spool axle, the spool axle and the spool rolling-element bearing being supported by the main frame when the aerial spool mechanism is in the operational configuration, the spool axle and the spool rolling-element bearing being spaced apart from the main frame when the aerial spool mechanism is in the reload configuration;
an electromechanical brake system being supported by the main frame and being connected to the main axle;
a remote controller spaced at least two meters from the main frame; and
an output signal conveyed from the remote controller to the electromechanical brake system such that the electromechanical brake system applies an adjustable rotational drag to the main axle in response to the output signal.

11. The aerial spool mechanism of claim 10, wherein the electromechanical brake system includes an electric actuator coupled to a brake, the electric actuator being supported by the main frame, the brake being connected to the main axle, and the aerial spool mechanism further comprising a hydraulic coupler that couples the electric actuator to the brake.

12. The aerial spool mechanism of claim 11, wherein the hydraulic coupler includes a fixed charge of a hydraulic fluid.

13. The aerial spool mechanism of claim 11, wherein the electromechanical brake system includes a lever and a master cylinder, wherein the electric actuator acts upon the lever, the lever acts upon the master cylinder, and the master cylinder delivers hydraulic pressure to the brake.

14. The aerial spool mechanism of claim 10, wherein the electromechanical brake system includes a power supply supported by the main frame and an electrical circuit connecting the power supply to the electric actuator, and the output signal is conveyed by a wireless communication link with a range of at least two meters to connect the remote controller in signal communication with the electrical circuit.

15. The aerial spool mechanism of claim 14, wherein the power supply is a battery.

16. The aerial spool mechanism of claim 10, wherein the output signal is conveyed by an electrical wire of at least two meters long between the remote controller and the electromechanical brake system.

17. An aerial spool mechanism for carrying a cable spool suspended from an aircraft, the aerial spool mechanism having selectively an operational configuration and a reload configuration, the aerial spool mechanism comprising:
a main frame;
a cable guide attached to the main frame;
a lift point connector on the main frame to facilitate connecting the aerial spool mechanism in suspension from the aircraft;
a main rolling-element bearing on the main frame;
a main axle supported by the main rolling-element bearing;
a spool axle to hold the cable spool, the spool axle being connected to rotate the main axle when the aerial spool mechanism is in the operational configuration, the spool axle being spaced apart from the main axle when the aerial spool mechanism is in the reload configuration;
a spool rolling-element bearing on the spool axle, the spool axle and the spool rolling-element bearing being supported by the main frame when the aerial spool mechanism is in the operational configuration, the spool axle and the spool rolling-element bearing being spaced apart from the main frame when the aerial spool mechanism is in the reload configuration;
an electromechanical brake system comprising an electric actuator, a lever, a brake, and a master cylinder; the electric actuator being supported by the main frame, the brake being connected to the main axle, the electric actuator moving the lever, the lever moving the master cylinder, and the master cylinder delivering hydraulic pressure to the brake;
a remote controller spaced at least two meters from the main frame; and
an output signal conveyed from the remote controller to the electromechanical brake system such that the electromechanical brake system applies an adjustable rotational drag to the main axle in response to the output signal.

18. The aerial spool mechanism of claim 17, wherein the electromechanical brake system includes a power supply supported by the main frame and an electrical circuit connecting the power supply to the electric actuator, and the output signal is conveyed by a wireless communication link with a range of at least two meters to connect the remote controller in signal communication with the electrical circuit.

19. The aerial spool mechanism of claim 18, wherein the power supply is a battery.

20. The aerial spool mechanism of claim 17, wherein the output signal is conveyed by an electrical wire of at least two meters long between the remote controller and the electromechanical brake system.
